(19) United States
(12) Patent Application Publication
(10) Pub. No.: US 2009/0241385 A1
(43) Pub. Date: Oct. 1, 2009

(54) Customizable adornment for tableware identification

(75) Inventor: Christina Andrea Johnson, State College, PA (US)

Correspondence Address: Kankindi Rwego, 1221 Westchester Ridge, N.E., Atlanta, GA, 30329, US

(73) Assignee: Panache Expressions, Inc., State College, PA (US)

(21) Appl. No.: 12/079,910

(22) Filed: Mar. 31, 2008

(51) Int. Cl. G09F 3/00

(52) U.S. Cl. 40/324

(57) ABSTRACT

A customizable adornment for tableware identification and a method of customizing adornments for catering, food service, or tableware wherein the adornment to a wine glass charm, napkin ring, appetizer pick, serving tray or other tableware and/or catering item is made distinguishable by removably attaching an interchangeable adornment which can represent an ornamentation, logo or icon. Given various social events, people can use wine glass charms, napkin rings, appetizer picks, and/or serving trays with different adornments that can symbolize the specific event, group or personal design. For instance, the adornment could be a clover to represent St. Patrick's Day or it could be an icon representing an organization such as a corporation, university or affiliation.

### BACKGROUND OF THE INVENTION

1. Field of the Invention

This invention relates generally to devices and methods and means for customizing tableware items such as stemware adornments, napkin rings, appetizer picks, and serving trays so that in addition to being separately distinguishable from similar items, they can be further customized to symbolize a specific event, group or personal design. More specifically, this invention relates to a method of identifying tableware with adornments that are removably attachable. Thus, the host can adapt the adornment to a particular event.

2. Description of the Related Art

The following art defines the present state of this field:

Hunter, U.S. Pat. No. Des. 47,490 describes an article of manufacture.

Danco, U.S. Pat. No. Des. 80,932 describes a tag for containers.

Hokerk, U.S. Pat. No. Des. 106,976 describes a combined cake of soap and support therefore.

Mazzini, U.S. Pat. No. Des. 269,899 describes a decorative chain segment.

Meyer, U.S. Pat. No. Des. 269,863 describes a segmented heart shaped pendant or similar article.

Rausch, U.S. Pat. No. Des. 406,213 describes a bottle collar.

Nahon, U.S. Pat. No. Des. 414,435 describes a bracelet thermometer for wine bottle

Klebeanow, U.S. Pat. No. 1,971,528 describes a display device for disposition upon the upper portion of a container comprising in combination a substantially flat sheet cut in the form of the form, a score line dividing the sheet into tow leaves, and a flap eccentrically cut from one of the leaves, said flap being smaller in diameter than said leaves and adapted to bend on said score line.

Brixius et al., U.S. Pat. No. 2,976,629 describes an identifying device capable of being removably affixed to the neck of a bottle, comprising a substantially planar circular plate adapted to receive identifying indicia thereon; engaging means adapted to engage the neck of said bottle to support said plate therefrom said engaging means being accurate in configuration with an inside diameter mateable with the outside diameter of said plate, means for pivotally affixing said engaging means to said plate at a peripheral point thereon, said engaging means being pivotable form a first position substantially in the plane of said plate to a second position substantially transverse thereto, said affixing means defining a radially inwardly extending resilient leg juxtaposed to one surface of sad plate and substantially parallel thereto.

Watson, Jr. U.S. Pat. No. 4,680,882 describes an identification tag for articles and containers, which is characterized by a base tag member having an extended leg for attachment to an article or looping through the handle of a container, the base tag member further provided with spaced indicia areas for identifying the article or the contents of the container and staggered snap openings extending through opposite faces of the base tag member for receiving at least a top cap member and preferably, a top cap member and a bottom cap member, each cap member having multiple snaps for engaging snap openings and provided with a window which is aligned with selected ones of the indicia areas when the cap members are snapped on opposite faces of the base tag member.

Bullock, U.S. Pat. No. 4,908,244 describes an ornamental device and kit therefor. In the preferred embodiment, layers of ornamental balls with progressively decreasing diameters are threaded down a shaft and nested together to simulate a Christmas tree. The kit may further include a protective support having pockets for receiving the various balls, base, shaft and decorative pinnacle for the dive.

King, U.S. Pat. No. 6,615,517 describes a beverage bauble comprising a glassware engaging member associable with a piece of beverage glassware and a primary identifier, wherein the primary identifier includes a connector which secures the primary identifier to the glassware engaging member.

Skapyak et al., U.S. Pat. No. 6,293,034 describes wine bottle rings and wine glass rings formed of spring steel in a loop having a pair of opposing and abutting ends. Said loops are of a size for accepting a stem of a wine glass forced through the abutting ends, and further, for being supported on a base of a wine glass when in use. The wine glass rings each provide a distinctive ornamentation so as to distinguish the wine glasses from each other.

Skapyak et al., U.S. Pat. No. 6,530,163 describes wine bottle rings and wine glass rings formed of spring steel in a loop having a pair of opposing and abutting ends. Said abutting ends are resiliently abutting ends for snapping onto and off the stems of stemware glasses.

Holmes et al., U.S. Pat. No. 6,741,150 describes a wine glass charm wherein the respective ends of an encircling member detachably attach the wine glass charm to the stem or handle of a drinking vessel are fastened by a magnetic coupling device.

Waymire, U.S. Pat. Des. Application No. US 2005/0016390 describes the method of making and use of stemware adornments having a helical memory shape that releasably receives an article such as a wine glass stem or a napkin.

Golove et al., Pat. Application No. US 2006/0185391 A1 describes a finger ring with a movable or removable setting and a charm coupled on a short chain.

The prior art teaches the use of decorative devices for visual appeal, see Hunter, Danco, Hokerk, etc. and for function, see, for instance, Raush, Nahon, and Klebanow. Such devices are generally used as identification means.

The prior art teaches the user of a bottle supported ring used as a carrier for wine glass supported decorative and identification rings such that one wine glass is clearly distinguishable from the next. The prior art teaches the use of identification rings such that one stemware glass is clearly distinguishable from the next. The prior art teaches the use of rings that have resiliently abutting ends for snapping onto and off the stems of stemware glasses. The prior art teaches stemware and napkin ring identification in the form of preformed helical shape which retains its helical shape during repeated use. See, Skapyak et al., U.S. Pat. No. 6,293,034, Skapyak et al., U.S. Pat. No. 6,530,163, and Waymire, U.S. Pat. Des. Application No. US 2005/0016390.

The prior art does not teach a customizable adornment feature. Customizable adornment features can accept adornments that are unique to an event, group or person. Given various social events, people can use various tableware items with different adornments that can symbolize the specific event, group or personal design The advantages over the prior art are that each tableware identification adornment can be customized for various organizations, events or personal groups yet still retain its main function of allowing people to distinguish their tableware items from those being used by others. Additionally, the user can use the same stemware adornment stems, rings, appetizer picks, but for other themed entertainment events. The present invention fulfills these needs and provides further related advantages as described in the following summary.

### SUMMARY OF THE INVENTION

A customizable tableware adornment comprising of a tableware item such as a wine glass charm, napkin ring, appetizer pick or serving tray wherein an end is adapted so as to receive a removably interchangeable head and a removably interchangeable head which is customized to represent a group, person or event.

The tableware item has an end which is threaded in a manner so as to accept heads which have 3 mm deep threaded holes. The heads could also be attached using a clip-on system or magnetic-locking system.

One embodiment is a customized stemware adornment that snaps onto the stem of a wine glass or drinking vessel that has a stem. The customized stemware adornment acts as a wine glass tag and is customizable to accept logos that are unique to an event, group or person. One advantage is that a user can use the same stemware adornment stems, but for other themed entertainment events simply by switching the heads.

One embodiment is a customized napkin ring that is customizable to accept logos that are unique to an event, group or person. A user can use the same napkin rings, but for other themed entertainment events by simply switching the heads.

One embodiment is a customized appetizer pick that acts as a toothpick assembly which is used to piercingly connect to a piece of garnish, such as an olive or cheese. The customizable appetizer pick has a unique logo that is removable and is specific to an event, group or personal design.

Other embodiments can include beverage charms or tags, serving tray handles, coasters, cork screw, and skewer. Each embodiment includes a unique logo that is removable and specific to an event, group or personal design.

### BRIEF DESCRIPTION OF THE DRAWINGS

FIG. 1A is a perspective view of a customizable stemware adornment that snaps onto the stem of a wine glass or drinking vessel that has a stem. The customized stemware adornment acts as a wine glass tag and is customizable to accept logos that are unique to an event, group or person. The drawings show several beads that have a stopper at the end. The threaded end is capable of receiving a charm, logo or tag that has an internal thread. The drawings show the means for attaching said adornment by screwing it into the thread abutting from the stopper.

FIG. 1B is a perspective view of a customizable stemware adornment that snaps onto the stem of a wine glass or drinking vessel that has a stem.

FIG. 1C is an exploded view of a customizable stemware adornment, showing the threaded end receiving a charm, logo or tag that has an internal thread.

FIG. 2A is plan view of a serving tray with handles that are capable of accepting customizable logos.

FIG. 2B is an exploded view of the customizable logo and serving tray handle assembly.

FIG. 3A is a perspective view of an appetizer pick with a customizable logo affixed thereto.

FIG. 4A is a plan view of a circular beverage charm with a customizable logo affixed thereto.

### DETAILED DESCRIPTION OF THE DRAWINGS

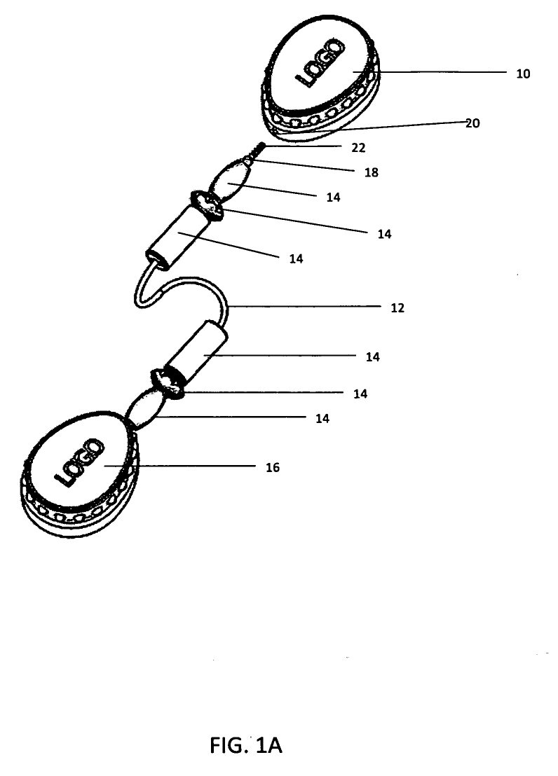

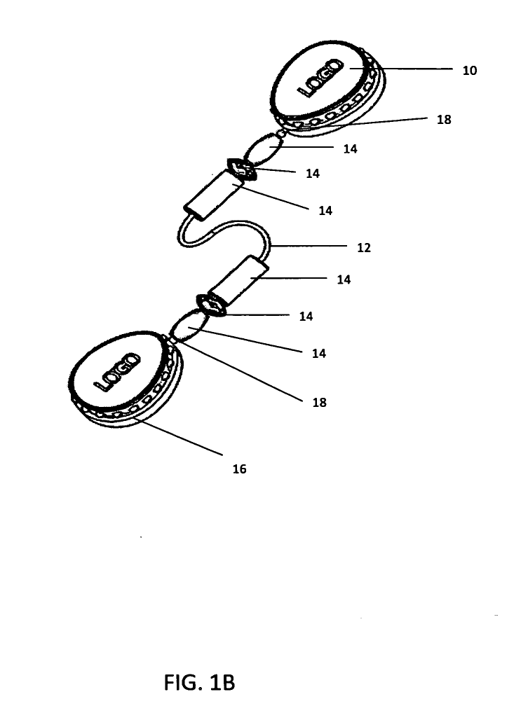

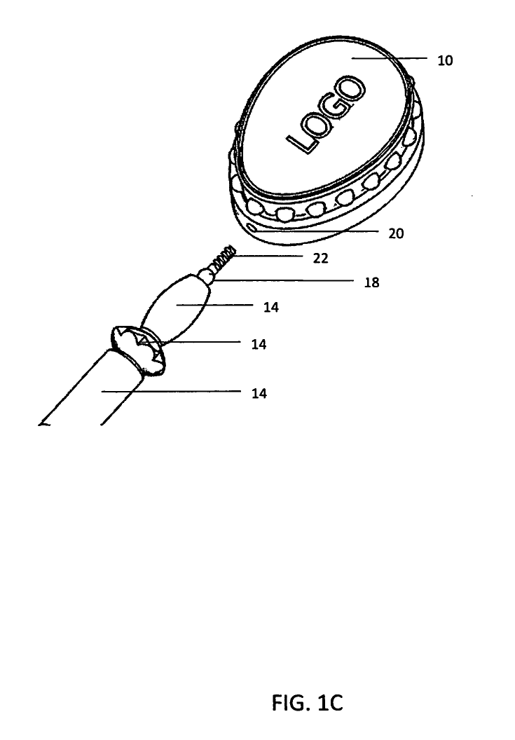

FIG. 1A is a perspective view of a customizable stemware adornment that snaps onto the stem of a wine glass or drinking vessel that has a stem. The customized stemware adornment acts as a wine glass tag and is customizable to accept logos (10) and (16) that are unique to an event, group or person. The drawing shows the stem (12) that accepts several beads (14) that have a stopper (18) at end of the stem (12). The threaded end (22) is capable of receiving a charm, logo or tag that has an internal thread (20). The drawing shows the means for attaching said adornment by screwing it into the thread abutting from the stopper.

FIG. 1B is a perspective view of a customizable stemware adornment that snaps onto the stem of a wine glass or drinking vessel that has a stem. The customized stemware adornment acts as a wine glass tag and is customizable to accept logos (10) and (16) that are unique to an event, group or person. The drawing shows the stem (12) that accepts several beads (14) that have a stopper (18) at end of the stem (12).

FIG. 1C is an exploded view of a customizable stemware adornment that snaps onto the stem of a wine glass or drinking vessel that has a stem. The customized stemware adornment acts as a wine glass tag and is customizable to accept logo (10) that is unique to an event, group or person. The drawing shows the threaded end (22) receiving a charm, logo or tag (10) that has an internal thread (20). The drawing shows the means for attaching said adornment by screwing it into the thread abutting from the stopper.

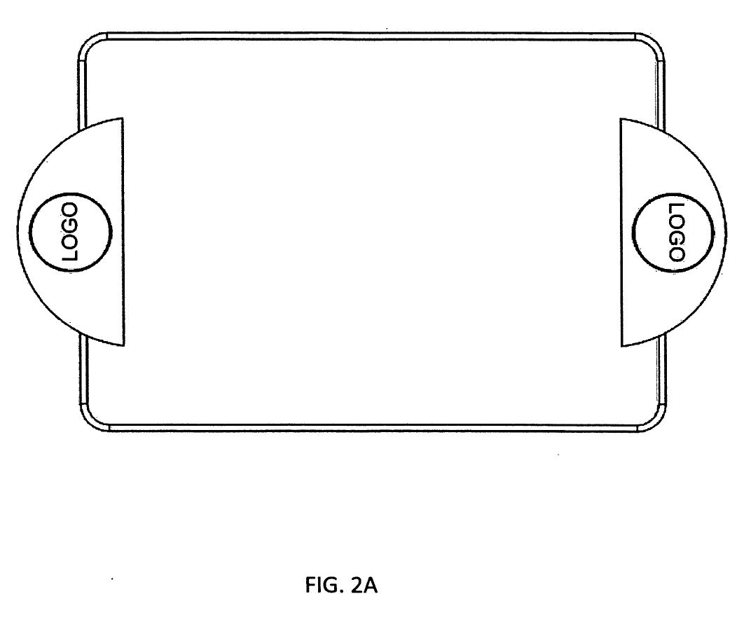

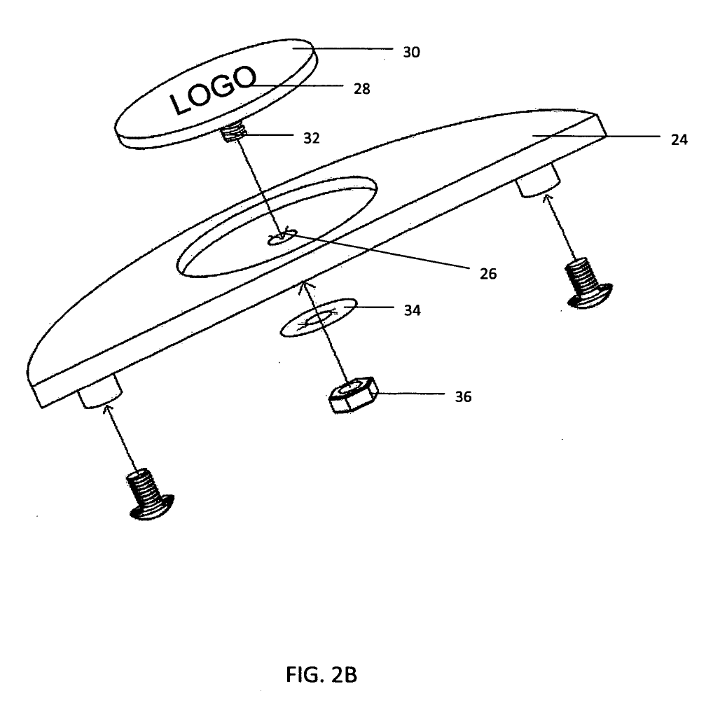

FIG. 2A is plan view of a serving tray with handles that are capable of accepting customizable logos.

FIG. 2B is an exploded view of a serving tray with customizable handles (24). Each handle has a centered threaded hole (26) centered into which a customizable logo (28) can be fitted. Said customizable logo (28) has a unique logo or symbol on its first surface (30) and a high thread abutting from its second surface (32). The customizable logo (28) is fixed into the serving tray handle (24) with a locking washer (34) and locking nut (36) mechanism.

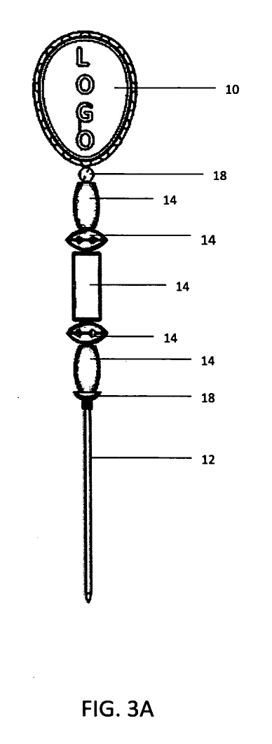

FIG. 3A is a perspective view of an appetizer pick. The customized appetizer pick adornment is customizable to accept logos (10) that are unique to an event, group or person. The drawing shows the stem (12) that accepts several beads (14) that have a stopper (18) at each end of the stem (12).

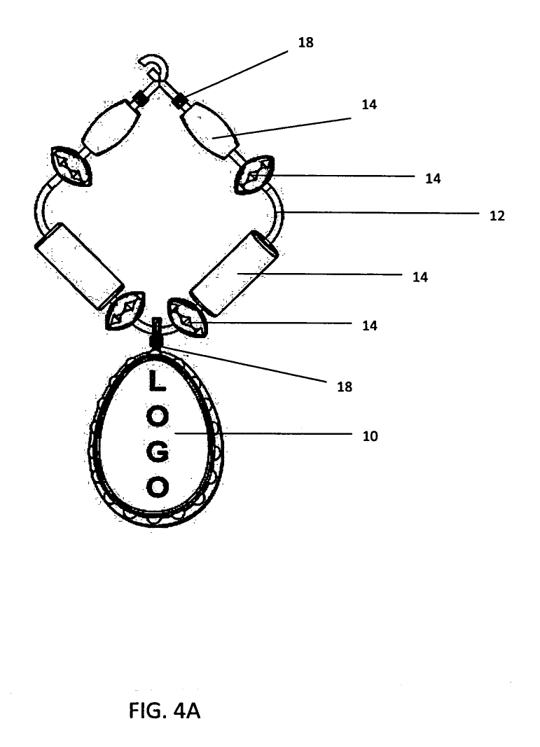

FIG. 4A is a plan view of a circular beverage charm. The customized beverage charm adornment is customizable to accept logos (10) that are unique to an event, group or person. The drawing shows the circular stem (12) that accepts several beads (14) that has a stopper (18) where the logo (10) attaches to the circular stem (12).

### Mode of Operation

The mode of operation of the invention comprises of adapting tableware devices such as wine glass charm, napkin ring, appetizer pick or serving tray to receive a removably interchangeable customizable adornments or logos which are customized to represent a group, person or event.

I claim:

1. A tableware identification device comprising of
A stem with at least one abutting high thread;
At least one Bead;
At least one Stopper; and
At least one customizable adornment having a design and a threaded hole centered at the bottom of said design.

2. The device of claim 1, wherein beads are decoratively arranged onto the stem.

3. The device of claim 2, wherein the beads are held in place by two stoppers located near each end of the stem.

4. The device of claim 3, wherein the stem has at least one high thread on at least one end of the stem.

5. The device of claim 4, wherein at least one customizable adornment having a design and threaded hole centered at the bottom of the design is inserted into at least one high thread end.

6. The device of claim 5, wherein the stem is flexible.

7. The device of claim 6, wherein the device is a napkin ring.

8. The device of claim 5, wherein the stem is non-flexible.

9. The device of claim 8, wherein the device is an appetizer pick.

10. The device of claim 5, wherein the stem is comprised of a 1 mm thick, 3¾ in. long, 19 gauge, polished stainless steel wire.

11. The device of claim 10, wherein the stem has 3 mm high thread at both ends.

12. The device of claim 11, wherein the device is a helical shaped wine glass charm.

13. The device of claim 10, wherein the stem is circular in shape having an abutting 3 mm high thread in the center of the stem.

14. The device of claim 13, wherein the device is a ring shaped wine glass charm.

15. A serving tray comprising of
At least one handle with a threaded hole incorporated therein;
At least one customizable logo with a high thread abutting therefrom;
At least one flat surface;
A locking washer; and
A locking nut.

16. The device of claim 15, wherein the customizable logo has a first surface and a second surface.

17. The device of claim 16, wherein a design is incorporated into the first surface and abutting from the second surface is a high thread capable of being inserted into the serving tray handle and affixed with a locking washer and locking nut mechanism.

18. A method of customizing adornments for tableware identification by removably attaching an interchangeable adornment.

19. The method of claim 18, further comprising of inserting at least one high thread abutting from a tableware device into at least one centered hole at the bottom of the adornment.

20. The method of claim 18, further comprising of inserting at least one high threaded customizable logo into at least one threaded hole tray handle and fixing the assembly with a locking washer and locking nut mechanism.
